(19) United States
(12) Patent Application Publication
(10) Pub. No.: US 2006/0187768 A1
(43) Pub. Date: Aug. 24, 2006

(54) Gear structure and timepiece having the same

(76) Inventor: Takuya Murazumi, Chiba-shi (JP)

Correspondence Address: BRUCE L. ADAMS, ESQ., SUITE 1231, 17 BATTERY PLACE, NEW YORK, NY, 10004, US

(21) Appl. No.: 11/356,693

(22) Filed: Feb. 17, 2006

(30) Foreign Application Priority Data
Feb. 22, 2005 (JP) 2005-046133

(51) Int. Cl. G04B 29/00

(52) U.S. Cl. 368/324

(57) ABSTRACT

To provide a gear structure easy to be attached and detached and a timepiece having the same. A gear structure includes a support shaft having a fitted shaft portion and a gear main body having fitting portions elastically fitted to the fitted shaft portion. The fitting portion of the gear main body and the fitted shaft portion of the support shaft are constituted such that the fitting portion of the gear main body is fitted to the fitted shaft portion of the support shaft in a state of prohibiting rotation of the gear main body relative to the support shaft. The fitting portion of the gear main body is constituted to be attachable and detachable to and from the fitted portion of the support shaft by being elastically deformed in D1, E1 and D2, E2 directions. The fitted shaft portion is provided with a noncircular sectional shape shifted from a circle centering on a rotation center axis line of the gear structure, and the fitting portion of the gear main body is provided with a noncircular opening fitted to the fitted portion of the support shaft, and spring portions constituting portions of a peripheral wall of the opening and elastically deformable in a diameter direction of the gear main body.

### BACKGROUND OF THE INVENTION

1. Field of the Invention

The present invention relates to a gear structure suitable for being used in a small-sized precision machine such as a timepiece and a timepiece having the same.

2. Description of the Prior Art

A gear structure constituted by fitting a gear main body to a support shaft is well known. However, according to the gear structure of the background art, the gear main body is fixed unremovably to the support shaft.

Therefore, according to the gear structure of the background art, even when damage (brake, warp or the like) deteriorating a function is brought about at only one of the support shaft and the gear main body, it is necessary to interchange a total of the gear structure. Further, since the support shaft and the gear main body of the gear structure are integrated, integration of the gear structure to an apparatus and removal from the apparatus, that is, attachment and detachment of the gear structure is not easy.

On the other hand, there is also known a gear structure constituted by relatively rotatably fitting a gear main body to a support shaft (for example, JP-UM-A-53-16755, JP-UM-63-183577, JP-UM-A-2-144790).

The gear structure of this kind of the background art includes a support shaft having a fitted shaft portion a section of which is a circular shape, and a gear main body having a fitting portion elastically fitted to the fitted shaft portion and mounted substantially unremovably to the fitted portion, and the fitting portion of the gear main body is fitted to the fitted shaft portion of the support shaft such that when a torque equal to or larger than a predetermined amount is applied thereto, slipping rotation relative to the support shaft of the gear main body is permitted. Further specifically, according to the gear structure of the background art, the fitted shaft portion is provided with a circular sectional shape centering on a rotation center axis line of the gear structure, the fitting portion of the gear main body is provided with a circular opening fitted to the fitted portion of the support shaft, and a spring portion constituting a portion of a peripheral wall of the opening and elastically deformable in a diameter direction of the gear main body, and when a torque equal to or larger than a predetermined amount is applied to the gear main body frictionally engaged with the fitting shaft portion by the spring portion, the gear main body is constituted to be slipped to rotate relative to the support shaft.

That is, according to the gear structure of the background art of a type of elastically fitting the gear main body to the support shaft, in order to frictionally engage the fitting portion of the gear main body to the fitted shaft portion of the support shaft at a predetermined level in order to make the gear main body enable to slip to rotate relative to the support shaft when a torque equal to or larger than a predetermined amount is applied thereto, the gear main body is elastically fitted to the support shaft, and when the gear main body is fitted to the fitted shaft portion of the support shaft at one end thereof, it is necessary to avoid the gear main body from being displaced in a direction other than a circumferential direction relative to the fitted shaft portion also by slipping rotation. That is, the gear structure of the background art of the type of elastically fitting the gear main body to the support shaft is on the premise of adopting a fitting structure actually prohibiting the gear main body from being detached from the support shaft. The gear structure per se of the slip rotation type is well known in the field of a timepiece as a structure of a minute indicator (center wheel & pinion) or the like.

However, for example, according to a small-sized precision machine such as a timepiece in which a number of gear trains or a train wheel are arranged by being overlapped not only in a direction in parallel with an extended face of a dial but also partially in a direction orthogonal to the dial, in the background art, gear main bodies and support shafts of respective gear structures are integrated and therefore, even when a malfunction is brought only in one gear structure, in a number of cases, so far as a machine apparatus including the number of gear trains or the train wheel is disintegrated into pieces, it is difficult to remove or interchange the malfunctioned gear structure.

The invention has been carried out in view of the above-described point and it is an object thereof to provide a gear structure which is easy to be attached and detached and a timepiece having the same.

### SUMMARY OF THE INVENTION

In order to achieve the above-described object, a gear structure of the invention includes a support shaft having a fitted shaft portion, and a gear main body having a fitting portion elastically fitted to the fitted shaft portion, wherein the fitting portion of the gear main body and the fitted shaft portion of the support shaft are constituted such that the fitting portion of the gear main body is fitted to the fitted shaft portion of the support shaft in a state of prohibiting rotation of the gear main body relative to the support shaft, and the fitting portion of the gear main body is constituted to be attachable and detachable to and from the fitted portion of the support shaft by being deformed elastically.

The gear structure of the invention “includes the gear main body having the fitting shaft portion elastically fitted to the fitted shaft portion of the support shaft, the fitting portion of the gear main body is constituted to be attachable and detachable to and from the fitted portion of the support shaft by being deformed elastically” and therefore, by only exerting an elastic force to the fitting portion of the gear main body, the gear main body can be removed from the support shaft, or the support shaft can be removed from the gear main body.

Therefore, for example, after drawing the support shaft by moving the support shaft in an axial direction or the like and mounting the support shaft to a predetermined position without being restricted by the gear main body by detaching the gear main body from the support shaft, the gear main body can be mounted to the fitting shaft portion on a side of an exposed end portion thereof or the like, not only assembling or disassembling is facilitated but also only a specific portion can also be interchanged selectively.

Further, according to the gear structure of the invention, “the fitting portion of the gear main body and the fitted shaft portion of the support shaft are constituted such that the fitting portion of the gear main body is fitted to the fitted shaft portion of the support shaft in the state of prohibiting rotation of the gear main body relative to the support shaft” and therefore, in a state of fitting the gear main body to the support shaft, the gear structure can function similar to an ordinary gear of the background art in which the shaft and the gear are integrated.

According to the gear structure of the invention, typically, the fitted shaft portion is provided with the noncircular sectional shape shifted from a circle centering on the rotation center axis line of the gear structure, and the fitting portion of the gear main body includes the noncircular opening fitted to the fitted portion of the support shaft, and the spring portion constituting a portion of the peripheral wall of the opening and elastically deformable in the diameter direction of the gear main body.

In this case, the gear main body can easily be attached and detached to and from the support shaft by only elastically deforming the spring portion. In order to elastically deform the spring portion, a previously prepared jig or the like may be used. Further, the fitting portion of the gear main body is provided with the noncircular opening and the support shaft is provided with the fitted shaft portion having the section in the noncircular shape and therefore, by only elastically deforming the fitting portion of the gear main body to be fitted to the fitted shaft portion of the support shaft, the gear portion can be mounted to the support shaft relatively unrotatably. Further, typically, although the noncircular shape of the opening substantially coincides with the noncircular shape of the section of the fitted shaft portion, so far as rotation of the gear main body relative to the support shaft can be prohibited by bringing a noncircular region of the peripheral wall of the opening into contact with a noncircular region of a portion of a peripheral face of the fitted shaft portion, depending on cases, the noncircular shape of the opening may differ from the noncircular shape of the section of the fitted shaft portion. Further, different from the case of slip rotation, it is not necessary to engage the both members by friction and therefore, shapes thereof relative to each other without rattle or play are selected. When the shape of the opening and the shape of the cross-sectional face of the fitted shaft portion are actually the same (similar), strictly, the fitted shaft portion is formed to be slightly larger than the opening such that the gear portion can be supported unmovably by the fitted shaft portion.

Further, the spring portion is typically constituted by a pair of arm portions extended substantially in a diameter direction to form springs supported by both sides thereof. However, when desired, spring performance may be provided to only one thereof, depending on cases, the spring portion may be constituted by a spring supported by one side thereof. Further, when desired, the spring portion may be constituted by three or more of spring portions. Further, the spring portion is operated in a direction along the extended face of the gear main body.

According to the gear structure of the invention, typically, cross-sectional faces of the opening and fitted shaft portion include a shape selected from a group consisting of a polygonal shape, an oval shape and a polygonal shape a corner portion of which is rounded. Here, the oval shape includes an elliptical shape, an oval shape in a shape of a track or the like. Although the polygonal shape is typically constituted by a quadrangular shape, the polygonal shape may be a pentagonal shape or a polygonal shape having more angles. Although a quadrangular shape is typically constituted by a quadrate or a rectangular shape, the quadrangular shape may be constituted by an oblong shape. Further, the shapes of the cross-sectional faces of the opening and the fitted portion are typically selected from a viewpoint of easiness in fabricating the gear main body and the support shaft. However, the shapes may be other shapes so far as relative rotation thereof can actually prohibited once fitted.

According to the gear structure of the invention, typically, a gear is constituted by a drawn member of a sheet metal. However, in place thereof, the gear may be constituted by an integrally molded resin or the like or may be formed by machining or the like.

The gear structure of the invention is typically used for a timepiece such as a wristwatch. However, the gear structure may be used other small-sized precision machines or the like or may be used in other apparatuses.

### BRIEF DESCRIPTION OF THE SEVERAL VIEWS OF THE DRAWINGS

A preferred form of the present invention is illustrated in the accompanying drawings in which:

FIG. 1 show preferable embodiments of a gear structure according to the invention, FIG. 1A is an explanatory view of a section of the gear structure (section taken along a line IA-IA of FIG. 1B), FIG. 1B is an explanatory view of a section taken along a line IB-IB of FIG. 1A, FIG. 1C is a plane explanatory view of a support shaft of the gear structure of FIG. 1A, and FIG. 1D is an explanatory view of a section taken along a line ID-ID of the support shaft of FIG. 1C (however, a state of being rotated by 45 degrees in comparison with FIG. 1B);

FIG. 2 show gears used in the gear structure of FIG. 1, FIG. 2A is a plane explanatory view of a gear of the gear structure of FIG. 1, and FIG. 2B is a plane explanatory view similar to FIG. 2A with regard to a modified example of the gear of FIG. 2A;

FIG. 3 show other modified examples of the gear of FIG. 2, FIG. 3A is a plane explanatory view of a gear having an opening in an elliptical shape, and FIG. 3B is a plane explanatory view of a gear having an opening in a shape of a track; and

FIG. 4 is an explanatory view of a section showing a portion of a timepiece integrated with the gear structure of FIG. 1;

FIG. 5 show portions of a support shaft of a gear structure used in the time piece of FIG. 4, FIG. 5A is a plane explanatory view, and FIG. 5B is a perspective explanatory view.

### DETAILED DESCRIPTION OF THE PREFERRED EMBODIMENTS

An explanation will be given of a preferable embodiment of the invention based on a preferable embodiment shown in the attached drawings.

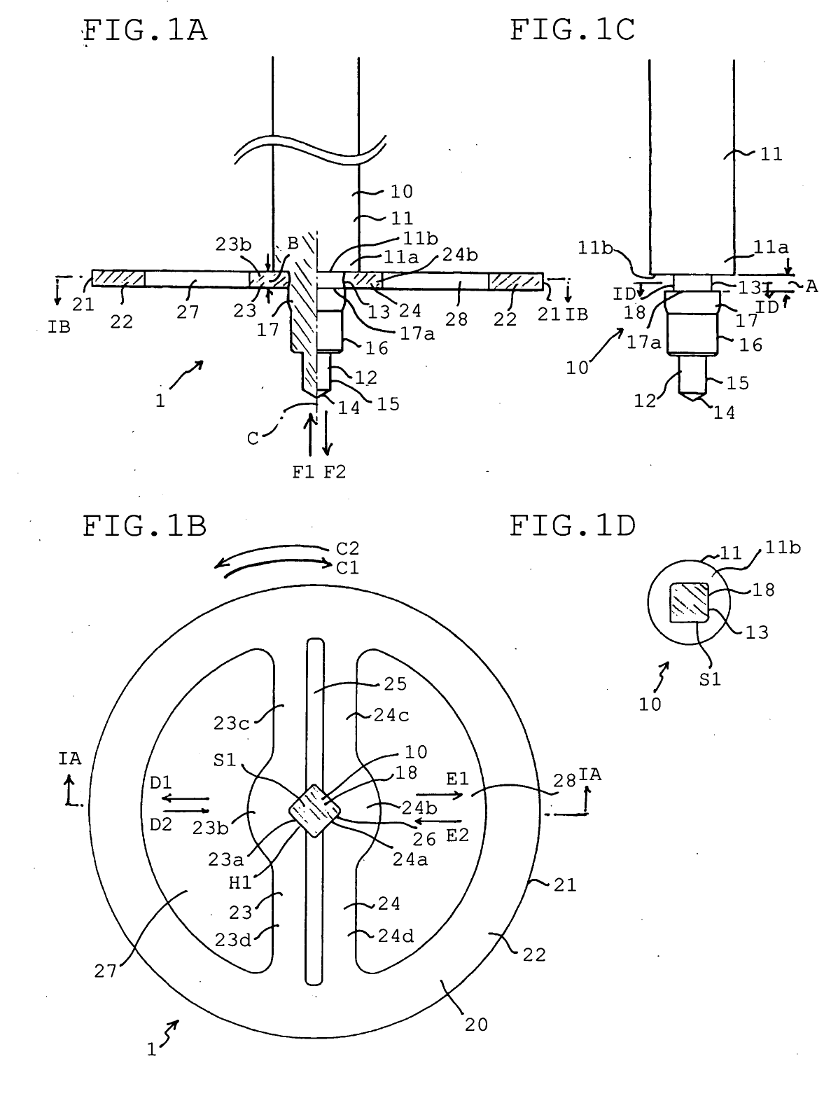

As shown by FIGS. 1A and 1B, a gear structure 1 of a preferable embodiment according to the invention is provided with a support shaft 10 and a gear main body 20.

As shown by FIGS. 1C and 1D, the support shaft 10 is provided with a shaft main body portion 11 in a shape of a circular pillar, a fitted axially supported end portion 12 at one end, and a fitted shaft portion 13 fitted with the gear main body 20. Further, a fitted axially supported end portion (not illustrated) similar to the fitted axially supported end portion 12 is formed also at the other end side of the shaft main body portion 11.

According to the example, the fitted axially supported end portion 12 includes a tenon 15 in a mode of a small diameter circular pillar shape portion supported by a bearing (not illustrated) such as a jewel. According to the example, a front end portion 14 of the tenon 15 is constituted by a conical shape. Further, the fitted axially supported end portion 12 includes a middle diameter circular pillar shape shaft portion 16 having a diameter larger than that of the tenon 15 and play or rattle. (not illustrated) having a pertinent size is formed between an end face of the shaft portion 16 and the bearing portion, not illustrated, such as the jewel.

The fitted shaft portion 13 includes a short and slender square pillar shape shaft portion 18 having a length A and a section in a square shape S1 formed between an end portion 11a of the large diameter shaft main body portion 11 and an inner side middle circular pillar shape portion 17 contiguous to the middle diameter circular pillar portion 16 and having a diameter larger than that of the middle diameter circular pillar portion 16. The fitted shaft portion 13 is constituted by the square pillar shape shaft portion 18, a contiguous end face 11b of the end portion 11a of the shaft main body portion 11 and a contiguous end face 17a of the inner side middle diameter circular pillar shape portion 17. The square pillar shape shaft portion 18 may be provided with more or less r (roundness) in the square shape S1.

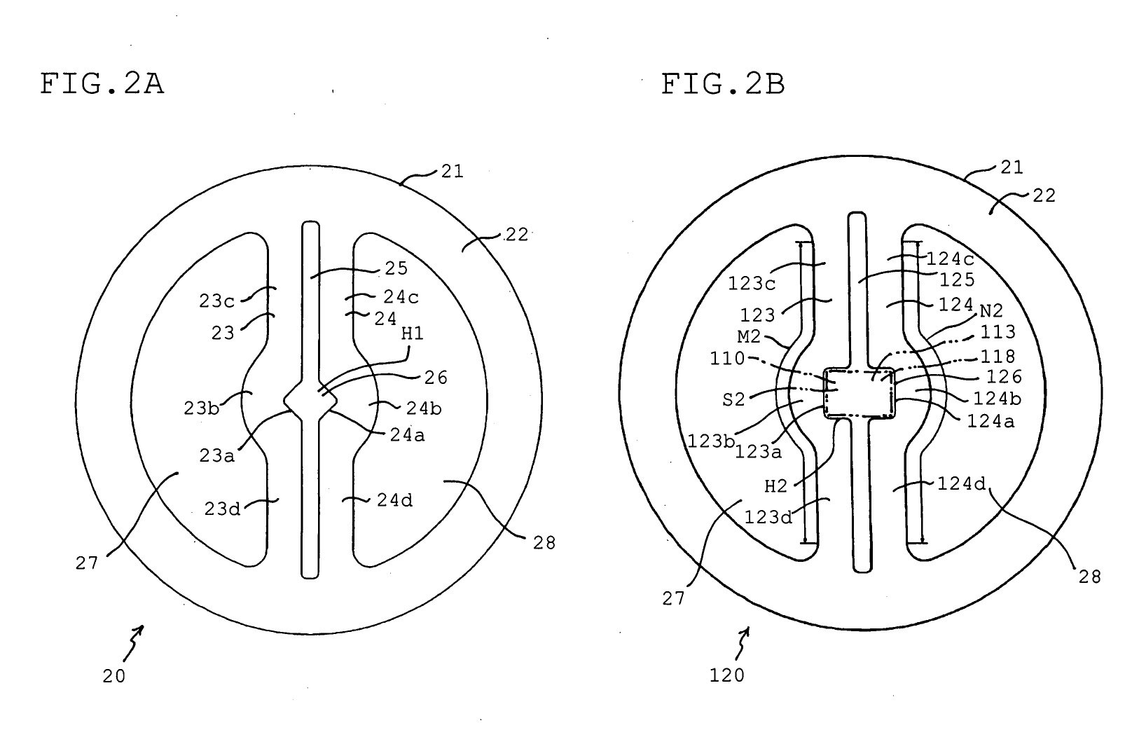

As shown by FIG. 2A, the gear main body 20 is provided with an outer shape in a shape of a circular plate as a whole. Further in details, the gear main body 20 includes a main body portion 22 in a shape of a circular ring having a gear portion or a meshed gear portion 21 at an outer periphery thereof and a pair of rib-like spring portions 23, 24. An opening or a hole 25 extended in a diameter direction is formed between the rib-like spring portions 23, 24. Notches 23a, 24a in a triangular shape are formed at regions of the rib-like spring portions 23, 24 opposed to a center of the circular ring 22, and a hole portion formed by the notches 23a, 24a forms an opening 26 in a square shape as a whole. A square shape H1 of the opening 26 actually coincides with the square shape S1 of the square pillar shape shaft portion 18 of the support shaft 10 except a fastening margin. In this case, the notches 23a, 24a are constituted by sides in a linear shape and therefore, the notches 23a, 24a are easy to fabricate. Further, the square shape H1 of the opening 26 may be provided with more or less r (roundness) at a corner portion thereof in order to avoid stress concentration. In that case, a radius of the r of the corner portion is equal to or smaller than a radius of r formed at the corner portion of the square pillar shape shaft portion 18.

The rib-like spring portions 23 and 24 are respectively constituted by boss-like portions 23b and 24b having wide widths at a center thereof and pairs of arm portions 23c, 23d and 24c, 24d, and the arm portions 23c, 23d and 24c, 24d integrally connect respectively the boss-like portions 23b and 24b and the circular ring shape portion 22. Therefore, there are formed opening portions 27, 28 in a fan shape expanded over a range of 180 degrees between the respective rib-like spring portions 23, 24 and the circular ring shape portion 22.

According to the example, the fitting portion of the gear main body 20 is constituted by the opening 26 and the rib-like spring portions 23, 24.

According to the gear structure 1 constituted as described above, the square pillar shape portion 18 of the support shaft 10 is fitted with the gear main body 20 by the opening 26 actually having a complementally shape except the fastening margin and therefore, when the gear main body 20 is applied with rotational torques in C1, C2 directions centering on the rotation center axis line C via the gear portion 21 at the outer periphery, the torques are transmitted to the square pillar shape shaft portion 18 of the support shaft 10 without slip or play via side edges of the notches 23a, 24a of the rib-like spring portions 23, 24 defining the opening 26 of the gear main body 20. That is, in operating the gear structure 1 as a gear, the support shaft 10 and the gear main body 20 can actually be regarded as an integrated member.

Further, strictly, the square shape H1 defined by the opening 26 of the gear main body 20 is formed to be slightly smaller than the square shape S1 defined by a cross-sectional face of the square pillar shape portion 18 of the support shaft 10, the gear main body 20 is fitted and fixed to the support shaft 10 in a state of exerting holding forces in D2, E2 directions to the square pillar shape portion 18 of the support shaft portion 10 by the rib-like spring portions 23, 24 by respectively bending the rib-like spring portions 23, 24 in D1, E1 directions in an extended face of the gear main body 20 at the boss-like portions 23b and 24b. In order to be able to permit such bending, the rib-like spring portions 23, 24 become slenderer than the boss-like portions 23b and 24b on both sides of the boss-like portions 23b and 24b. Further, the center portions of the rib-like spring portions 23, 24 become the boss-like portions 23b, 24b having the wide widths in order to prevent an excessive deformation from being brought about at the center portions.

According to the example, a thickness B of the rib-like spring portions 23, 24 of the gear main body 20 substantially coincides with the length A of the square pillar shape portion 18 of the support shaft 10, strictly, the thickness B is slightly smaller than the length A such that the boss-like portions 23b, 24b can be fitted between end faces 11b, 17a of the support shaft 10 at side edges of the notch portions 23a, 24a. However, it is preferable that the thickness B is approximate to the length A in order to maintain the rib-like spring portions 23, 24 of the gear main body 20 in a state of being orthogonal to the center axis line C of the support shaft 10. Further, the thickness B of the boss-like portions 23b, 24b may differ from a thickness of other portions of the gear main body 20.

When the gear main body 20 is fitted to the support shaft 10, for example, the support shaft 10 is erected, the rib-like spring portions 23, 24 are forcibly elastically deformed in D1, E1 directions in the extended face of the gear main body 20 by a previously prepared jig or the like to open (expand) the opening 26 of the gear main body 20 in D1, E1 directions, the gear main body 20 expanded with the opening 26 is pressed in F1 direction to the support shaft 10 in the erected state to ride over the middle shaft portions 16, 17 from the side of the tenon 15, when the boss-like portions 23b, 24b are fitted to the square pillar shape shaft portion 18, deformation of the spring portions 23, 24 by the jig or the like is released, and the gear main body 20 is fitted to the support shaft 10. Further, when the opening 26 is expanded by deforming the spring portions 23, 24, it is preferable to prevent warp or waviness in the thickness direction from being brought about at the spring portions 23, 24 or the like.

Conversely, when the gear main body 20 is detached from the support shaft 10, for example, a previously prepared desired tool or jig or the like is engaged with the opening 25 of the gear main body 20 fitted to the support shaft 10 in the erected state, the opening 26 is expanded by deforming the rib-like spring portions 23, 24 in D1, E1 directions by a tool or jig or the like, the gear main body 20 is moved in F2 direction relative to the support shaft 10 as staying in the state and is detached from the side of the tenon 15 via the middle shaft portions 17, 16.

Further, so far as the gear main body 20 can be fitted to the support shaft 10 attachably and detachably and relatively unrotatably, the shape of the cross-sectional face of the fitted shaft portion 13 of the support shaft 10 and the shape of the opening 26 of the gear main body 20 substancially in correspondence therewith may differ from each other. Further, for example, one of the spring portions 23, 24 may not be provided, for example, one of the openings 27 and 28 may not be provided.

In the following, some modified examples of the shape of the opening 26 of the gear main body 20 will be shown.

An opening 126 for fitting a gear main body 120 may be constituted by a square shape H2 in which two sides thereof are extended in parallel with a direction of extending an opening 125 in a diameter direction and remaining two sides are directed in a direction of being extended in a direction orthogonal to the direction of extending the opening 125 in the diameter direction as shown by FIG. 2B instead of the square shape H1 inclined by 45 degrees to the opening 25 in the diameter direction as shown by FIG. 2A. Although in this example, the square shape H2 is not a quadrate shape but rectangular shape prolonged laterally, when desired, the square shape H2 may be a quadrate shape. In this case, the gear main body 120 is constituted similar to the gear main body 20 except that rib-like spring portions 123, 124 are provided with notches 123a, 124a in a mode of recess portions having side edges and bases in parallel with each other to form the opening 126 of the square shape H2 as a whole. Also in this case, the notches 123a, 124a comprise sides in a linear shape and therefore, fabrication thereof is facilitated. Further, in FIG. 2B, portions or positions in FIG. 2B similar to those of FIG. 2A are attached with the same notations and portions different therefrom although corresponding thereto are added with notation 1 at the position of the FIG. 100. Also in this case, a corner portion may be formed to be rounded in order to avoid the corner portion from being concentrated with a stress.

Also in the gear main body 120, according to the rib-like spring portions 123, 124, totals M2, N2 of the arm portions 123c, 124c and 123d, 124d as well as the center boss-like portions 123b, 124b are respectively operated as springs.

As shown by an imaginary line in FIG. 2B, it is apparent that the gear main body 120 having the opening 126 in the square shape H2 can be fitted to the support shaft 110 of the gear main body 120 attachably and detachably and relatively unrotatably even when the gear main body 120 is fitted to the support shaft 110 having the fitted shaft portion 113 comprising the shaft portion 118 in a shape of a square pillar of a shape S2 substantially complementally with the square shape H2. Further, although in FIG. 2B, an outer peripheral edge of the shaft portion 113 of the support shaft 110 is shown at an interval from an inner peripheral edge of the opening 126 to be easy to see, actually, an outer peripheral face of the shaft portion 113 is brought into close contact with an inner peripheral face of the opening 126. Further, in the case of the example, in comparison with the gear main body 20, the rib-like spring portions 123, 124 are difficult to be exerted with forces deviated in D1, E1 directions by a rotational torque applied to the gear main body 120.

Although in the above-described, an explanation has given of the example in which the shapes H1, H2 of the openings and the corresponding shapes S1, S2 of the shaft portions are constituted by a quadrangular shape, a polygonal shape may be constituted by a hexagonal shape or a polygonal shape having more angles, further, may be a polygonal shape including an odd number of sides or angle portions as in a pentagonal shape. Further, although typically, the corresponding notches 23a, 24a or 123a, 124a are provided with shapes in mirror symmetry, depending on cases, the shapes may be shifted from mirror symmetry, or shapes quite different from shapes in mirror symmetry relative to each other.

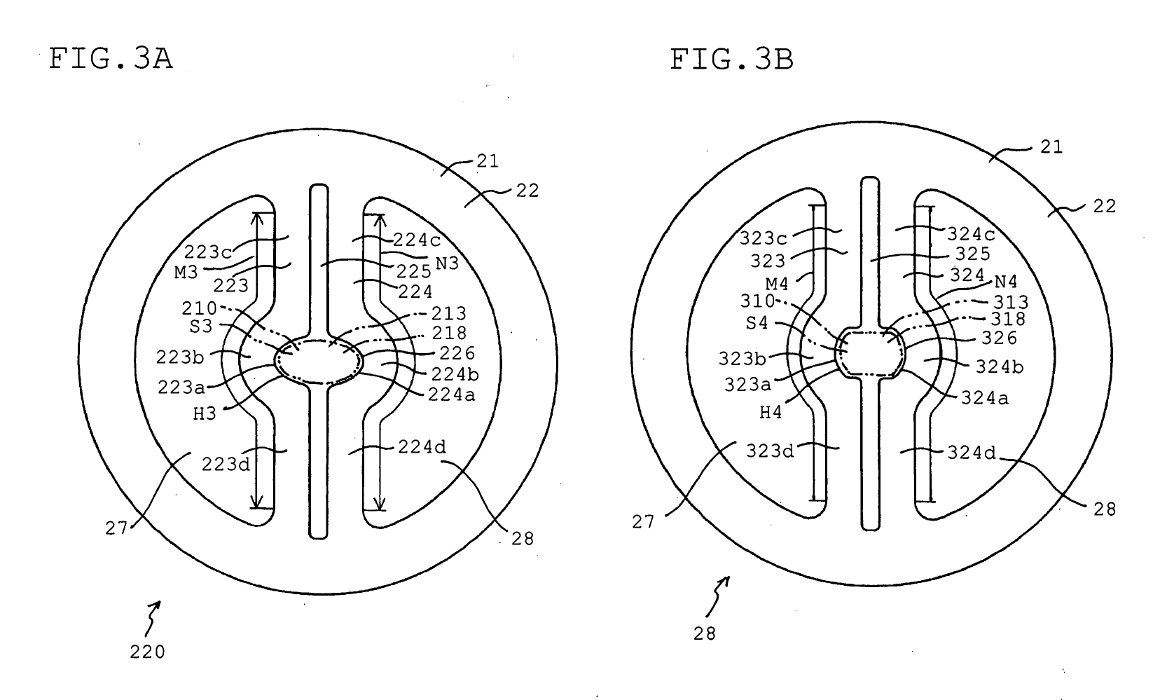

As shown by FIG. 3A, an opening 226 for fitting a gear main body 220 maybe constituted by an elliptical shape H3 having a long axis in a direction orthogonal to a direction of extending an opening 225 in a diameter direction. In this case, the gear main body 220 is constituted similar to the gear main body 20 or 120 except that rib-like spring portions 223, 224 are provided with notches 223a, 224a in a recess shape having depths deeper than widths thereof to form the opening 226 in the elliptical shape H3 as a whole. Further, in FIG. 3A, portions or positions similar to those of FIG. 2A are attached with the same notations and portions thereof different therefrom although corresponding thereto are added with notation 2 at the position of the FIG. 100.

Further, also in this case, according to the rib-like spring portions 223, 224, totals M3, N3 of pairs of the arm portions 223c, 224c and 223d, 224d as well as the center boss-like portions 223b, 224b are respectively operated as springs. According to the gear main body 220, a peripheral edge portion of the opening 226 is not provided with a corner portion and therefore, there is less concern of concentrating a stress to a specific position.

As shown by an imaginary line in FIG. 3A, it is apparent that the gear main body 220 can be fitted to the support shaft 210 attachably and detachably and relatively unrotatably also when the gear main body 220 having the opening 226 in the elliptical shape H3 is fitted to the support shaft 210 having the fitted shaft portion 213 comprising the shaft portion 218 in the elliptical shape of a shape S3 substantially complementally with the elliptical shape H3. Here, the long axis of the elliptical shape may be extended in parallel with the direction of extending the opening 225. Further, the elliptical shape may be constituted a slender circular shape which is not strictly an ellipse. Further, although in FIG. 3A, the outer peripheral edge of the shaft portion 213 of the support shaft 210 is shown at an interval from the peripheral edge of the opening 226 to be easy to see, actually, an outer peripheral face of the shaft portion 213 is brought into close contact with an inner peripheral face of the opening 226.

Further, as shown by FIG. 3B, an opening 326 for fitting a gear main body 320 may be constituted by an oval shape H4 in a shape of a track which is slender in a direction orthogonal to a direction of extending an opening 325 in a diameter direction and an outer periphery of which comprises a linear portion and a portion in a shape of a circular arc. In this case, the gear main body 320 is constituted similar to the gear main body 20 or 120 or 220 except that rib-like spring portions 323, 324 are provided with recess shape notches 323a, 324a having depths deeper than widths thereof to form the opening 326 in the oval shape H4 in the shape of the track as a whole. Further, in FIG. 3B, portions or positions similar to those of FIG. 2A are attached with the same notations and portions different therefrom although corresponding thereto are added with notation 3 at the position of the FIG. 100.

Further, also in this case, according to the rib-like spring portions 323, 324, totals M4, N4 of pairs of arm portions 323c, 324c and 323d, 324d as well as center boss-like portions 323b, 324b are respectively operated as springs.

As shown by an imaginary line in FIG. 3B, it is apparent that the gear main body 320 can be fitted to the support shaft 310 attachably and detachably and relatively unrotatably also when the gear main body 320 having the opening 326 of the oval shape H4 in the shape of the track is fitted to the support shaft 310 having the fitted shaft portion 313 comprising the shaft portion 318 in the oval shape in the shape of the track of the shape S4 substantially complementally with the oval shape H4 in the shape of the track. Further, although in FIG. 3B, an outer peripheral edge of the shaft portion 313 of the support shaft 310 is shown at an interval from an inner peripheral edge of the opening 326 to be easy to see, actually, an outer peripheral face of the shaft portion 313 is brought into close contact with an inner peripheral face of the opening 326. Also in the case of the example, since a peripheral edge of the opening 326 is not provided with a corner portion, a stress can be avoided from being concentrated on a specific portion of the peripheral edge of the opening 326.

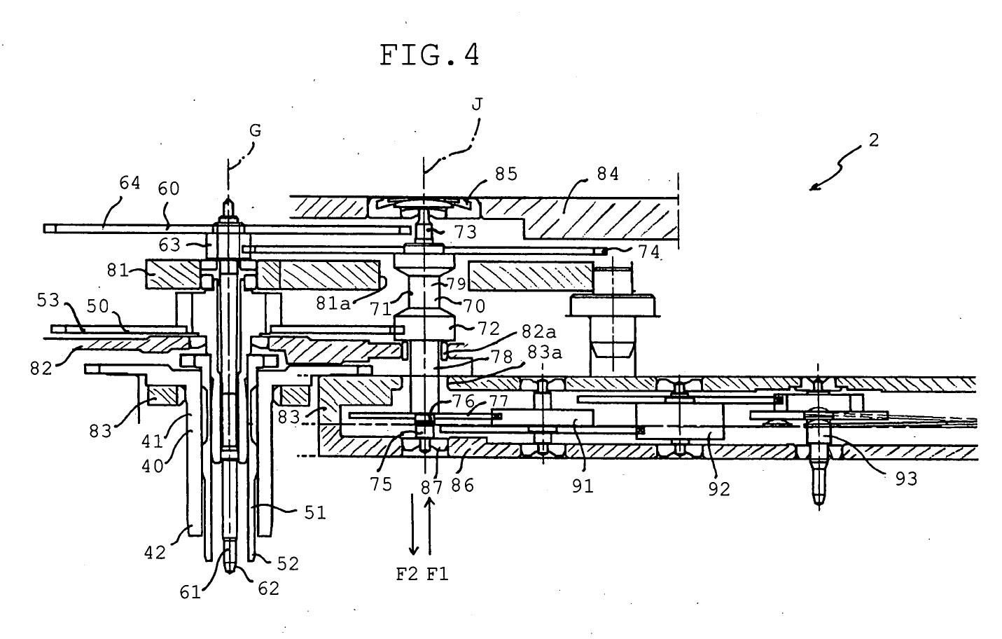

The gear structure 1 constituted as described above is integrated to a wristwatch 2 shown in, for example, FIG. 4.

In the wristwatch 2 of FIG. 4, an hour wheel 40, a center wheel & pinion 50 and a fourth wheel & pinion 60 are rotatably and coaxially arranged around a center axis line G. And an hour hand and a minute hand, not illustrated, are attached to a front end portion 42 of a cylinder portion 41 of the hour wheel 40 and a front end portion 52 of a cylinder portion 51 of the center wheel & pinion 50. Further, in this example, a front end portion 62 of a stem 61 of the fourth wheel & pinion 60 is not used and therefore, the front end portion 52 of the cylinder portion 51 may be closed. Further, the fourth wheel & pinion 60 is supported by a train wheel bridge 81, the center wheel & pinion 50 is supported by a second bridge 82, and the hour wheel 40 is supported by a second main plate 83.

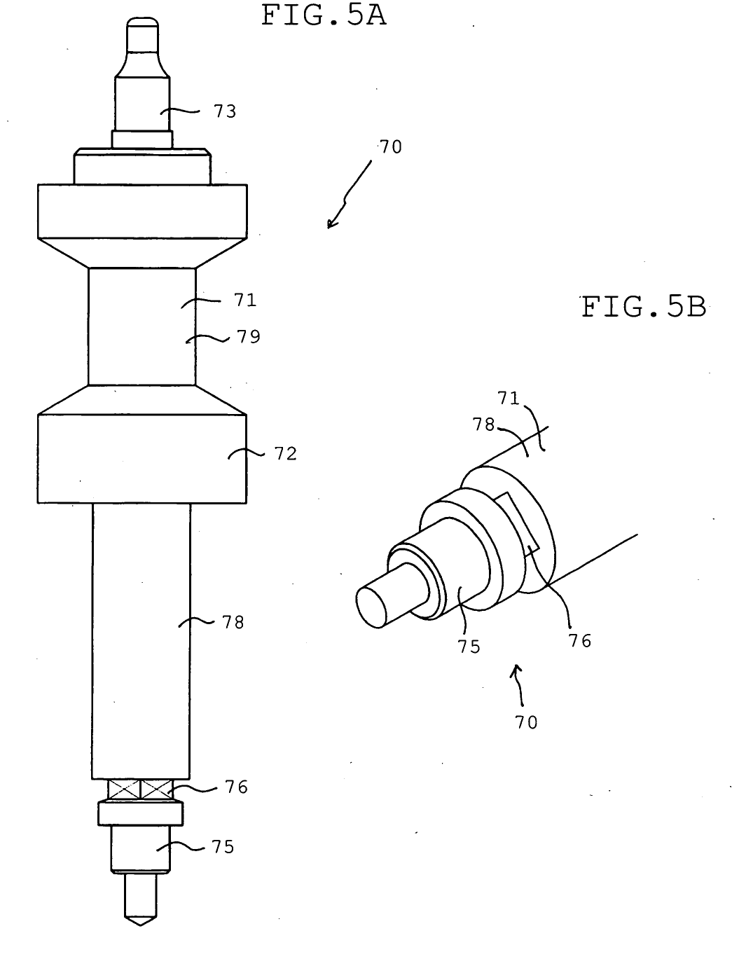

A third wheel & pinion 70 is provided with a first intermediate second wheel 77 fitted to a fitted shaft portion 76 on a side of the other end 75 of a stem 71 in addition to the third stem 71, a third pinion 72 formed at a middle portion of the stem 71, and a third wheel 74 fitted to a side of one end 73 of the stem 71. Further, a detailed structure of the third wheel & pinion 70 is shown by an enlarged view in FIGS. 5A-5B with regard to a state of not being mounted with the first intermediate second wheel 77 (however, illustration of the third wheel is omitted). The third stem 71 is rotatably supported around a center axis line J by a bearing 85 of a main plate 84 and a bearing 87 of a second train wheel bridge 86. The third wheel & pinion 70 is brought in mesh with the center wheel 53 of the center wheel & pinion 50 by the third pinion 72, and brought in mesh with a fourth pinion 63 of the fourth wheel & pinion 60 by the third wheel 74. A fourth wheel 64 is connected to a speed control or escapement mechanism.

Further in details, the third wheel & pinion 70 is fitted loosely to an opening 83a of the second main plate 83 and fitted to a bearing portion 82a disposed at an opening of the second bridge 82 slidably rotatably at a shaft portion 78 between the third pinion 72 and the first intermediate second wheel 77. Further, the third wheel & pinion 70 is loosely fitted to a large opening 81a of the train wheel bridge 81 at a shaft portion 79 between the third wheel 74 and the third pinion 72. A diameter of the opening 81a is larger than an outer diameter of the third pinion 72, and the third wheel & pinion 70 can be inserted in F2 direction from a side of the end portion 74 via the opening 81a of the train wheel bridge 81, a hole of the bearing 82a of the second bridge 82 and the opening 83a of the second main plate 83 in a state in which the stem 71 is not mounted with the first intermediate second wheel 77.

Further, the first intermediate second wheel 77 can rotate a second indicator 93 via second and third intermediate second wheels 91, 92 rotatably supported between the second main plate 83 and the second train wheel bridge 86. A second hand (not illustrated) is attached to a front end of a shaft 93a of the second indicator 93. In this case, the second hand is rotated centering on a position different from that of the hour hand and the minute hand. Naturally, the second hand can also be attached to the front end portion 62 of the fourth stem 61 and therefore, a timepiece main body having two kinds of indication possibilities is formed without changing other portions.

According to the timepiece 2, the third wheel & pinion 70 can not only receive rotation of the center wheel & pinion 50 by the third pinion 72 to transmit to the fourth wheel & pinion 60 via the third wheel 74 but also transmit to the second and third intermediate second wheels 91, 92 and the second indicator 93 via the first intermediate second wheel 77. That is, the third wheel & pinion 70 can output two outputs via the two wheels by receiving one input. Such an operation can be carried out because the two wheel portions are provided other than the pinion portion.

Here, the third wheel & pinion 70 corresponds to the gear structure 1 of FIG. 1, the third stem 71 corresponds to the support shaft 10 of FIG. 1 and the first intermediate second wheel 77 corresponds to the gear main body 20 of FIG. 1. Further, the fitted shaft portion 76 of the third stem 71 corresponds to the fitted shaft portion 13 of FIG. 1, further in details, the shaft portion 18.

According to the timepiece 2, the third wheel & pinion 70 and the like can be integrated to an inner portion of the timepiece 2 by inserting a shaft portion 78 of the third stem 71 of the third wheel & pinion 70 into the opening 82a of the second bridge 82 via the opening 81a of the train wheel bridge 81 from the side of the end portion 75 in a state of not being mounted with the first intermediate second wheel 77, making the end portion 73 of the third wheel & pinion 70 supported by the bearing 85 of the main plate 84, thereafter, arranging the second main plate 83 such that the third stem 71 is loosely fitted to the opening 83a by reverting upside down, further, fitting the first intermediate second wheel 77 to the fitted shaft portion 76 of the third wheel & pinion 70 and attaching the second and third intermediate second wheels 91, 92 as well as the second indicator 93 and thereafter, arranging the second train wheel bridge 86.

In the wheel 70 having the wheel portion 72 for one input and the wheel portions 74, 77 for two outputs in this way, when assumedly, the wheel portion (first intermediate second wheel) 77 is previously attached fixedly to the stem 71, large openings capable of inserting the wheel portion (first intermediate second wheel) 77 need to be formed at the train wheel bridge 81 and the second bridge 82 and the second main plate 83 and the like. Therefore, not only there is a concern of being devoid of stability in supporting the third wheel & pinion 70 since the shaft portion 78 cannot be supported by a bearing but also the stem 71 of the third wheel & pinion 70 needs to be extremely bold and a rotational load is liable to be increased. According to timepiece 2, such a drawback can be avoided by making the wheel portion (first intermediate second wheel) 77 of the stem 71 of the third wheel & pinion 70 attachable and detachable to and from the third stem 71 and fitting the wheel portion (first intermediate second wheel) 77 to the third stem 71 to be unrotatable relative to each other in a mounted state.

The third wheel & pinion 70 shown in FIG. 4 and FIGS. 5 is simply an example of the gear structure 1, and the gear structure 1 may be used at any other portion. The gear portion 77 may constitute an input portion instead of constituting the output portion.

What is claimed is:

1. A gear structure comprising:
a support shaft having a fitted shaft portion; and
a gear main body having a fitting portion elastically fitted to the fitted shaft portion;
wherein the fitting portion of the gear main body and the fitted shaft portion of the support shaft are constituted such that the fitting portion of the gear main body is fitted to the fitted shaft portion of the support shaft in a state of prohibiting rotation of the gear main body relative to the support shaft; and
wherein the fitting portion of the gear main body is constituted to be attachable and detachable to and from the fitted portion of the support shaft by being deformed elastically.

2. A gear structure according to claim 1, wherein the fitted shaft portion is provided with a noncircular sectional shape shifted from a circle centering on a rotation center axis line of the gear structure; and
wherein the fitting portion of the gear main body includes a noncircular opening fitted to the fitted portion of the support shaft, and a spring portion constituting a portion of a peripheral wall of the opening and elastically deformable in a diameter direction of the gear main body.

3. A gear structure according to claim 2, wherein the opening is provided with a shape selected from a group consisting of a polygonal shape, an oval shape, and a polygonal shape a corner portion of which is rounded.

4. A gear structure according to claim 1, wherein a gear is a drawn member of a sheet metal.

5. A gear structure according to claim 1, wherein the gear is a gear for a timepiece.

6. A timepiece including the gear structure according to claim 1.
